(19) United States
(12) Patent Application Publication
(10) Pub. No.: US 2005/0231891 A1
(43) Pub. Date: Oct. 20, 2005

(54) High energy-density electric double-layer capacitor and energy generation systems thereof

(76) Inventor: Troy A. Harvey, Salt Lake, UT (US)

Correspondence Address: Troy A Harvey, 7875 Da Vinci Dr., Salt Lake City, UT, 84121, US

(21) Appl. No.: 11/109,153

(22) Filed: Apr. 19, 2005

Related U.S. Application Data
(60) Provisional application No. 60/563,311, filed on Apr. 19, 2004.

(51) Int. Cl. H01G 9/00

(52) U.S. Cl. 361/502

(57) ABSTRACT

An electric double layer capacitor includes polarizable electrodes immersed in an organic electrolyte, wherein the electric double layer capacitor exhibits a high energy density. Also disclosed is a method of coupling an electric double layer capacitor to photovoltaic and variable energy generation systems.

### CROSS-REFERENCES TO RELATED APPLICATIONS

This application claims the benefit of U.S. Provisional Patent Application No. 60/563,311 entitled “High energy-density electric double-layer capacitor and energy generation systems thereof”, and filed on Apr. 19, 2004 for Troy Aaron Harvey.

### BACKGROUND OF THE INVENTION

1. Field of the Invention

The present invention relates to polarizable electrodes used in an electric double layer capacitor and methods for constructing the same. The present invention also relates to a method of and a system for energy generation, wherein said capacitor(s), by storing energy, are used to moderate systems having photovoltaic and/or other periodic electricity generators such that energy is available on demand even when the periodic energy generator is either not producing power or not producing sufficient power to meet the needs of the load(s).

2. Discussion of Prior Art

2.1 Electric Double Layer Capacitors Utilizing the electric double-layer in capacitors has substantially increased the specific capacitance achievable, and thus energy density achievable, as compared to conventional capacitors. Despite this, the present art for double-layer capacitors exhibit low volumetric energy densities as compared to electrochemical batteries.

This is largely the result of application specific product research and development that first targeted small microelectronic uses, and later pulse-power. Since the late 1970s, several firms have been producing small electric double-layer capacitors aimed at memory backup and the like, with capacities ranging from fractional farads to approximately ten farads.

After garnishing military interest in double-layer capacitors for pulse-power devices in the 1980s, the market interest shifted towards other pulse-power applications, such as the emerging electric and hybrid vehicle marketplace. This further focused institutional development efforts towards pulse power and load leveling applications. As a result, the vast majority of double-layer capacitor development has been for pulse power (Maxwell, EPCOS, Okamura, NEC, Montena, Saft, Nesscap, Panasonic, Telecordia, Skeltech, Sandia National Labs, Livermore National Labs, Federal Fabrics, etc.).¹
¹ Ultracapacitor technology—status, projections, and R&D needs. Internations Seminar on DLCsm 2003, 2002, 2001, 2000 A. F. Burke

The demands of the marketplace drove electric double-layer capacitor research and development, and, at the same time, electric double-layer capacitor development has been constrained by the conventional view that a capacitor is a power delivery rather than an energy storage device. As a result, the prior art has been designed for high power to energy ratios to efficiently handle the high current flows of pulse-power systems. In turn, electric double-layer capacitors have suffered from very low packaged energy densities (typically less than 5 Wh/liter), a high cost per watt-hour of capacity, high rates of self-discharge, low scalability, per-application custom design of the capacitor arrays, and other issues that have limited their use as bulk energy storage in periodic energy systems.

2.2 Energy Storage Moderated Periodic Sources of Energy

Many sources of energy are periodic in nature. This includes many environmental sources of energy, such as photovoltaic, thermo-electric solar generators, wind turbines, tidal generators, thermal gradient generators, and the like. It also includes heat, combustion, electrochemical, and thermo-chemical sources of energy that are operated intermittently, such as combustion powered generator sets, gas turbines, sterling engines, and fuel cells.

To provide reliable on-demand power, periodic sources of electrical energy must be coupled with an energy storage sub-system. Such storage moderated energy sources are quite common, especially in photovoltaic, solar, wind, combustion generator sets, and combination systems thereof. In these systems, typically the generator only supplies a few hours of power per day. The energy storage must provide the energy needed until the generator power becomes available again. Energy storage is also required to provide additional peak-power capability when the energy generator(s) cannot provide sufficient power to meet the instantaneous power requirements of the load. Because the periodicity of these energy sources is often unpredictable, the energy storage subsystem typically contains between 12 hours and 20 days worth of backup storage depending on load requirements, generator technology, installation locale, and power reliability required.

2.3 Storage: Prior Art

Currently, lead-acid batteries are the standard method of energy storage for periodic energy generation systems because there are few other viable options, both in terms of performance and economics. And yet lead-acid batteries are the leading source of failures, reliability problems, life-cycle cost, and other problems in these systems.

For example, lead-acid batteries dominate photovoltaic energy storage due to a lack of feasible alternatives, though they poorly match photovoltaic performance requirements. The lead-acid batteries in these systems have low energy efficiency, low energy availability, short life spans, high maintenance requirements, poor reliability, safety hazards, and environmental disposal problems. Though photovoltaics have the potential for exceptionally clean energy production, currently the high embodied energy and low energy efficiency of battery storage is such that the energy payback period consumes a major portion of total system life

Electric double-layer capacitors possess several desirable characteristics that address the shortcomings of lead-acid batteries in periodic energy systems. Most notable amongst these attributes are a high charge efficiency which can approach 100%, a cycle-life two orders of magnitude greater than batteries, a maintenance-free sealed cell chemistry, and the opportunity to use environmentally-friendly materials. However, existing electric double-layer capacitor technologies possess a number of limiting attributes, including low energy density, high material cost per unit of energy stored, toxic electrolytes, and high rates of self-discharge. These characteristics have made electric double-layer capacitors previously inapplicable as storage in photovoltaics and other periodic energy systems.

### SUMMARY OF THE INVENTION

The present invention provides a novel electrode which can then be used to build novel electric double layer capacitors which have sufficient packaged volumetric energy density to be practically useful for bulk energy storage, low material requirements in order to make the capacitor sufficiently economical, and having a low self-discharge rate in order to provide sufficient charge retention over long storage periods.

Furthermore, certain embodiments of the invention enable coupling high energy-density capacitors to photovoltaics and other periodic sources of energy in order to create a system that provides reliable on-demand power.

With the description as provided below, it is readily apparent to one skilled in the art that various double-layer capacitors can be created using a variety of materials to form various configurations of the disclosed electrode. The present invention relates the above features and objects individually as well as collectively. These and other objects, features and advantages of the present invention will become apparent to those skilled in the art from the following description and drawings.

### BRIEF DESCRIPTION OF THE DRAWINGS

FIG. 1 is a cross-sectional view illustrating an arrangement of a high energy-density double-layer capacitor according to one embodiment of the current invention;

FIGS. 2A-2D are perspective views illustrating the production steps of a process of making a series connected stack of high energy-density electric double-layer capacitors according to one embodiment of the current invention using polymer pouch packaging arranged into a single capacitor high-voltage module;

FIGS. 3A-3C are perspective views illustrating the production steps of a process of making a series connected bipolar stack of high energy-density electric double layer capacitors according to one embodiment of the current invention arranged into a single capacitor high-voltage module;

FIG. 4 is a perspective view illustrating a wound cylinder type packaging of a high energy-density electric double-layer capacitor according to one embodiment of the current invention.

FIG. 5 is a schematic process flow chart diagram illustrating one embodiment of a method of using the present invention for moderating the electric output of a photovoltaic generator system;

FIG. 6 is a schematic process flow chart diagram illustrating one embodiment of a method of using the present invention for moderating the electric output of a periodic energy generator or a multiplicity thereof;

FIG. 7 is a graph illustrating a relative packaged energy density of a multi-cell stack of electric double layer capacitors verses electrode thickness in accordance with one embodiment of the present invention;

FIG. 8 is a table of capacitor examples comparing selected embodiments of the present invention to those typical of the prior art.

### DESCRIPTION

High Energy-Density Double-Layer Capacitor Embodiments

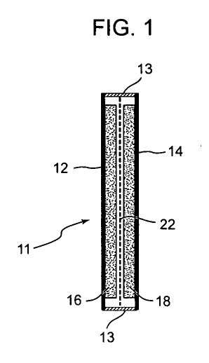

Explanation will be made below with reference to FIGS. 1-4 for illustrative embodiments concerning the high energy-density electric double-layer capacitor and the method for producing the same according to the present invention.

In its fundamental form, the high energy-density double-layer capacitor according to the present invention includes, for example, the type of unit cell 11 as shown in the cross-sectional view in FIG. 1. The unit cell 11 comprises a positive polarizable electrode 16 and a negative polarizable electrode 18, which are formed on or conductively attached to two collectors 12 and 14. The two collectors 12 and 14 provide a conduction path out of the cell. The unit cell 11 further comprises an optional separator 22 which is interposed between the polarizable electrodes 16 and 18 to provide electrical isolation between the electrodes while allowing electrolyte conductivity. The separator 22 may be comprised of a porous polymer, cellulose, paper, glass matt, or non-porous ion conducting membrane. In the depicted embodiment, aluminum or conductive polymers, as blended with a carbon material, are used for the collectors 12, 14, and unit cell 11 is immersed or filled with an organic electrolyte and then sealed with end caps 13 in order to contain the electrolyte.

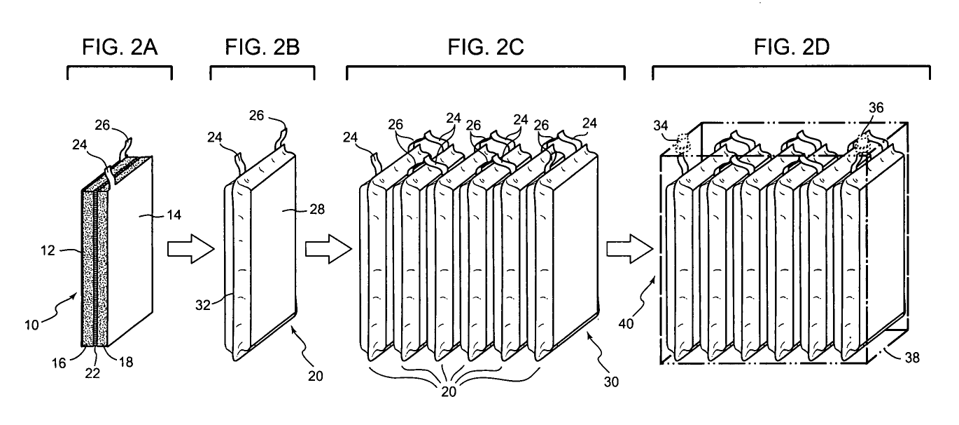

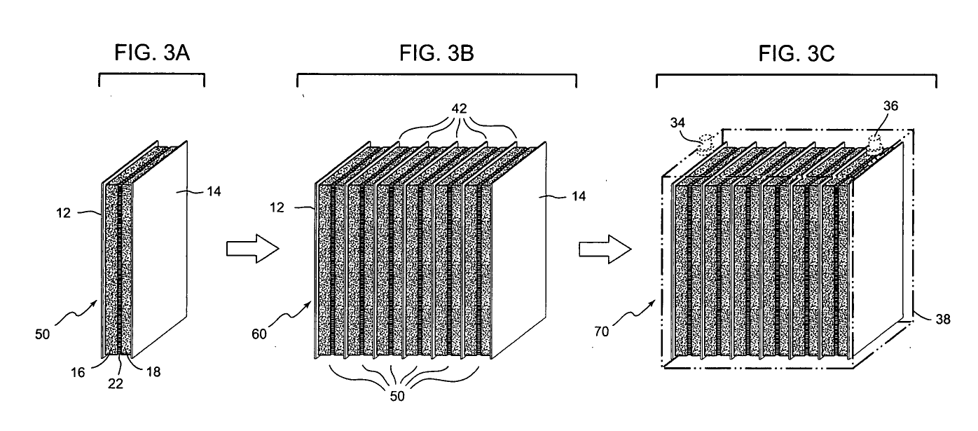

Multiple unit cells may also be connected in series or parallel electrical arrangements (or combinations thereof) in a single package in order to provide a higher voltage stack, as depicted in FIGS. 2A to 2D and FIGS. 3A to 3C.

In one such embodiment, a type of capacitor module 40, shown in FIG. 2D, is constructed using a multiplicity of unit cells 10. As depicted, each of the unit cells 10 in FIG. 2A includes a positive polarizable electrode 16 and a negative polarizable electrode 18, which are formed on or conductively attached to two collectors 12 and 14. Electrical leads 24 and 26 enable conduction of electricity out of the cell 10. The unit cell 10 may include an optional separator 22 interposed between the polarizable electrodes 16 and 18 to provide electrical isolation between the electrodes while allowing electrolyte conductivity.

As shown in FIG. 2B, the unit cell 10 may subsequently be sealed in a polymer, foil or foil-polymer package 28 and filled with an organic electrolyte. The edges 32 may be sealed, forming an enclosed unit cell 20 having electrical leads 24, 26 emerging from the package.

A multiplicity of packaged unit cells 20 may be assembled in a stack, such as the series assembly shown in FIG. 2C, wherein the cell leads 24, 26 are alternatively connected in series, positive to negative. The depicted cells 20 are enclosed in an optionally air-tight container 38, shown in FIG. 2D, to form a singular packaged unit 40 having positive and negative terminals 34, 36, which are electrically attached to the end leads of the multi-cell stack.

In another embodiment, a type of bipolar capacitor module 70, illustrated in FIG. 3C, may be constructed using a multiplicity of unit cells 50, where each of the unit cells 50, shown in FIG. 3A, includes a positive polarizable electrode 16 and a negative polarizable electrode 18 formed on or conductively attached to two collectors 12 and 14. The unit cell 50 further includes an optional separator 22 interposed between the polarizable electrodes 16 and 18 to provide electrical isolation between the electrodes while allowing electrolyte conductivity. In the depicted embodiment, aluminum or conductive polymers may be used for the collectors 12, 14 respectively, and a carbon material formed according to one embodiment of the present invention As shown in FIG. 3B, a multiplicity of unit cells 50 are stacked in a bipolar arrangement 60, such that each positively polarized electrode shares an electrical collector 42 with the negatively polarized electrode of the adjacent cell. In order to conduct electricity through the full face of the collector, each cell in turn may be stacked accordingly until the end cells terminate in the end collectors 12 and 14.

The assembled stack 60 may be immersed in an organic electrolyte and sealed in an enclosed air-tight container 38, shown in FIG. 3C, to form a singular packaged unit 70 having positive and negative terminals 34, 36 which are electrically attached to the end collectors of the multi-cell stack.

Both types of flat plate capacitors 40, 70 are characterized such that a high degree of charge can be affected, a large size can be obtained, and the volumetric energy density of such arrangements is high, most especially in the bipolar arrangement 70.

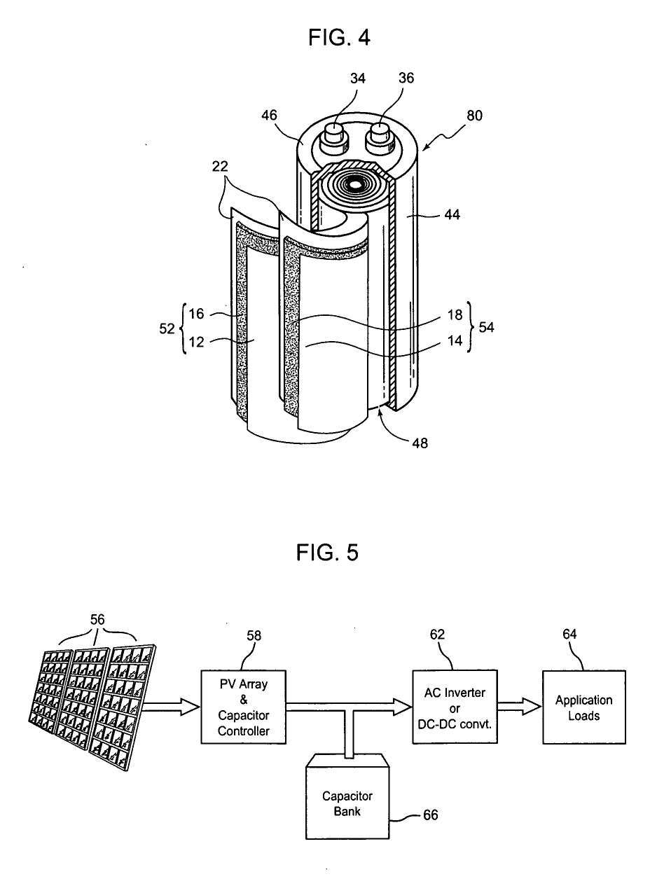

In addition to the flat type high energy-density electric double-layer capacitors described above, a wound type capacitor 80 is also possible as shown in FIG. 4. The high energy-density double-layer capacitor 80 may include a wound core 48 composed of a positive electrode sheet 52 that includes a positive polarizable electrode 16 formed on or conductively attached to a collector 12 and a negative electrode sheet 54 wound to have a cylindrical configuration with a separator 22 interposed there between.

The wound core 48 may be accommodated, for example, in a cylindrical aluminum or polymer-foil case 44, which may be filled with an organic electrolyte (not shown). The case 44 may be sealed with a top plate 46 through which terminals 34, 36 carry the electricity from the aforementioned collectors 12, 14.

The carbon material used for the electric double layer capacitor electrodes 26, 28, according to one embodiment of the present invention, may be comprised of a carbon, activated carbon, and carbon black, graphitic carbon, alkali activated graphitic or non-graphitic carbon (processed at high temperatures with alkalis such as KCO₃, KOH, K, Na, NaOH, NaCO₃, etc), carbon fibers, carbon nanotubes, carbon fibrils, or a combination thereof. Such carbons or mixtures thereof may also contain a fluorine-containing polymer, as a binding agent, such as polytetrafluoroethylene (PTFE), an ethylene-tetrafluoroethylene copolymer (ETFE), a chlorotrifluoroethyl-ethylene polymer (PCTFE), a vinylidene fluoride copolymer (PVDF), a tetrafluoroethylene-hexafluoropropylene copolymer (FEP), or a tetrafluoroethylene-perfluoroalkylvinyl ether copolymer (PFA). Alternatively, the binder may also be comprised of a polyolefin polymer or co-polymer, such as polypropylene, polyethylene, ethylene-octene, or ultra high molecular weight polyethylene.

In certain embodiments, the carbons may be bound together with a carbon-bearing substance, emulsion or adhesive and formed into blocks or sheets and processed into a conductive electrode at a high temperature. The high temperature process of pyrolyzation leaves behind only a conductive carbonaceous remnant of the binder. Such carbon bearing substances may include methyl cellulose, polyvinylidene difluoride, coal tar, petroleum tar, asphaltenes, cellulose, starches, and proteins; preferred carbon-bearing substances being thermosetting resins, such as phenolic, resorcinol, or furfural resins. Alternatively, the carbon may be produced as a monoblock formed from carbon-bearing precursors such as methyl cellulose, polyvinylidene difluoride, coal tar, petroleum tar, cokes, asphaltenes, hemicellulose, cellulose, lignins, starches, proteins, phenolic resins, furfural resins, and epoxide resins and subsequently carbonized to form a solid electrode.

The electrostatic capacity of the electrode, as expressed in farads, is developed between the solute ions of the organic electrolyte and the carbon of the electrode, whether the ions forming the electrostatic storage field are adjacent to the carbon surface, diffused, absorbed on the carbon surface, or through insertion between carbon layers.

In one embodiment, the solute of the organic electrolyte includes, but is not limited to, one of the following anions: tetrafluoroborate (BF₄—), hexafluorophosphate (PF₆—), hexafluoroarsenate (AF₆—), perchlorate (ClO₄—), CF₃SO₃—, (CF₃SO₂)₂N—, C₄F₉SO₃—. The solute of the organic electrolyte may include, but is not limited to, the following cations:

One cation may be represented by the following formula:

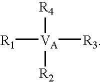

Wherein the central atom V_{A} is one of the periodic table group VA elements (N, P, As . . . ) and where the four radicals R₁, R₂, R₃, R₄ may individually support one of the following groups: methyl, ethyl, propyl, butyl, or pentyl. Examples include tetraethylammonium (Et₄N+) and 1-methyl-3-ethylphosponium (Et₃MeP+). Alternatively, any two of the radical attachment points may support a cyclic hydrocarbon. Examples include dialkylpyrrolidinium or dialkylpiperidinium.

Another cation can be represented by the following formula:

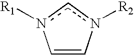

Wherein R₁ and R₂ are alkyl groups each having from 1 to 5 carbon atoms, R₁ and R₂ may be the same group or different groups. An example of which is 1-ethyl-3-methylimidazolium.

The solvent of the organic electrolyte may be a dipolar aprotic solvent. Examples include, but are not limited to: propylene carbonate (PC), butylene carbonate (BC), ethylene carbonate (EC), gamma-butyrolactone (GBL), gamma-valerolactone (GVL), glutaronitrile (GLN), adipnitrile (ADN), acetonitrile (AN), sulfolane (SL), trimethyl phosphate (TMP), dimethyl carbonate (DMC), ethyl methyl carbonate (EMC), or diethyl carbonate (DEC).

A solvent comprised of a mixture composed of a primary solvent containing at least one aprotic solvent, such as those mentioned above, and a secondary solvent containing either another of said dipolar aprotic solvents, or another non-polar organic co-solvent may also be used.

With the use of ionic liquids, such as the aforementioned imidazolium cation containing ionic liquids, the electrolyte may contain only a neat ionic liquid, and no other solvent. Alternatively, the ionic liquid co-solves another solute of cations and anions.

Cell Conformations

The physical conformation of a cell design has a dramatic effect on the behavior of the electric double layer capacitor. Below the cell conformation design according to one embodiment of the present invention is described in greater detail.

The manner in which the electrodes are formed, the carbons used to form them, and the density achieved by those carbons both have a large effect on the final electric double-layer capacitor's energy density, efficiency in operation, and rate of self discharge. Equations affecting its performance are listed below:

| | | |
|---|---|---|
| Cell electrode volume: | Vol = T · A | Where T is the thickness of a pair of |
| | | electrodes within a cell, and A is the |
| | | surface area of those electrodes. |
| Capacitive density: | D_{cap} = F_{g} · d | Where D_{cap} in the capacitive density |
| | | of the electrodes measured in |
| | | farads/cc. And F_{g} is the specific |
| | | capacity of the carbon in farads per |
| | | gram, and d is the density of the |
| | | carbon in g/cc. |
| Cell energy: | $E = \frac{Vol \cdot {D}_{cap} \cdot {V}^{2}}{7200}$ | Where E is the energy storage ability of the cell in Watt-hours, and V is the voltage of the cell. |
| Cell resistance: | ${R}_{ave} = \frac{T}{2 A} RS$ | Where Rₐᵥₑ is the average resistance of the cell, as calculated from the center of each electrode, and RS is the resistivity of the cell, measured in ohm-cm). |
| Power: | $P = \frac{E}{RAT}$ | Where P is power required by the system, and RAT is the ratio of energy storage of the cell to power requirements expressed in Wh/W. |
| Power loss: | ${P}_{loss} = {( \frac{P}{\sqrt{{V}^{2} \cdot SOC}} )}^{2} {R}_{ave}$ | Where Pₗₒₛₛ is the power losses, in watts, due to cell resistance at a given cell state-of-charge (SOC). |
| Capacitor efficiency: | $Eff = 1 - \frac{{P}_{loss}}{P}$ | Where Eff is the efficiency of the capacitor. |
| By substitution we can arrive at: | ${T}^{2} \cdot D = \frac{\text{14,400} \cdot RAT \cdot SOC \cdot ( 1 - Eff )}{RS}$ | |

The above equation provides means to calculate the allowable conformations of a capacitor given the energy-power ratio requirements and resistivity of the cell while maintaining the required efficiency at a specific state-of-charge. It should be noted that the two fundamental factors in efficiency are electrode thickness (T) and capacitive density (D). At the same time as seen in FIG. 7, on a relative scale, packaged volumetric energy density is fundamentally a function of electrode thickness and capacitive density. While voltage has a sustainable effect on the final capacitor volumetric energy density, the curve profiles of the non-linear increase in energy density as a function of thickness remains virtually the same, as seen in FIG. 7. By increasing electrode thickness taking advantage of energy density improvements, being a non-linear function of electrode thickness, and increasing the capacitive density while balancing energy efficiency is a fundamental object of the present invention.

In the present invention, the following values were assumed based on experimental results. Cell resistivity (RS) of between 25 to 400 ohm-cm based on typical organic electrolytes within a porous carbon electrode, wherein the ratio (RAT) of the energy capacity of the capacitor bank at top-of-charge, to the peak power of the energy generation system, as measured in watt-hours per watt (Wh W) is greater than 5 and less than 300 Wh/W, and preferably is greater than 4 and less than 300 Wh/W, and more preferably is greater than 3 and less than 300 Wh/W, and most preferably greater than 2 Wh/W with no particular upper limit. Because the ohmic efficiency of an electric double-layer capacitor decreases as the SOC decreases, the minimum efficiency that can be tolerated is chosen near the lowest practical SOC. However, since energy storage used in periodic energy systems typically spend the majority of their time at high SOC, average efficiency would be correspondingly higher than this amount. Herein a preferred efficiency is 90% at 10% SOC, though depending on the application 75%, 50%, or lower efficiency at 10% SOC may be chosen.

Given the above equations and parameters, and concerning the present invention, a new set of conformations may be chosen providing efficient operation in periodic energy systems as specified by the present invention while providing a substantially higher energy density than achievable by standard means. These conformations are: where T²*D is equal to a value greater than 10 and less than 6500, and preferably a value greater than 5 with no particular upper limit, and more preferably a value greater than 1.44 with no particular upper limit, and most preferably a value greater than 0.70 with no particular upper limit.

Synergistically, increased electrode thicknesses and capacitive electrode densities also serve to lower self-discharge rates substantially below that of the prior art.

Capacitor Moderated Energy Generator Embodiments

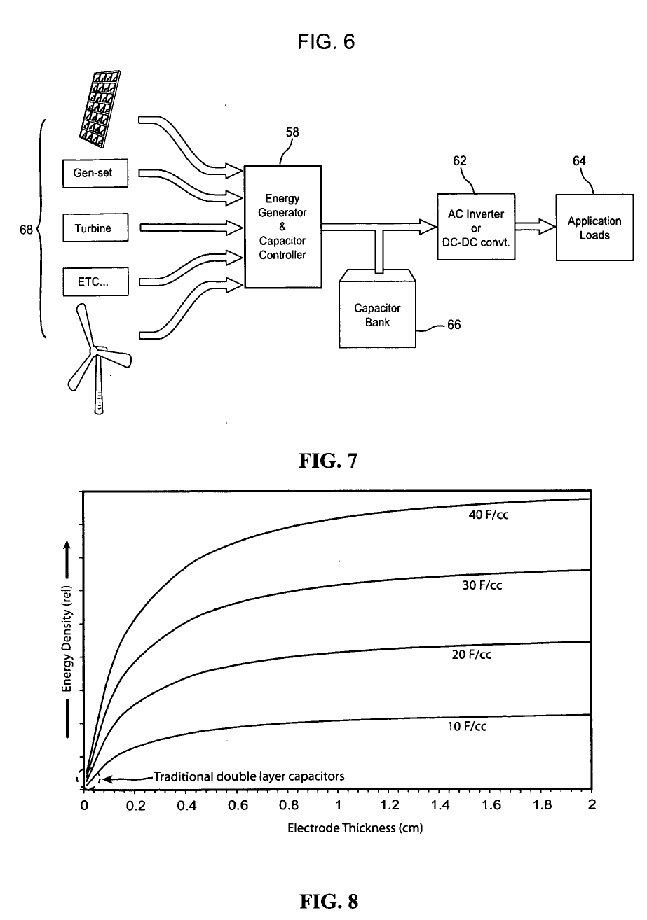

Explanation will be made below with reference to FIGS. 5-6 for illustrative embodiments concerning energy systems consisting of periodic energy generator(s) and a high energy-density electric double layer capacitor(s) and a method for constructing the same, according to the present invention.

One embodiment of a photovoltaic energy generation system is shown in diagram FIG. 5. Electricity may be generated by a photovoltaic generator, array of photovoltaic cells, or photovoltaic panels 56 on a periodic basis according to the variable and cyclic nature of solar isolation. The energy generated by the photovoltaic array may be efficiently stored in the capacitor bank 66, such that energy is available on demand even when the photovoltaic generator 56 is either not producing power or not producing sufficient power to meet the needs of the load 64. The ratio of the energy capacity of the capacitor bank at top-of-charge, to the peak power of the photovoltaics, as measured in watt-hours per watt (Wh/W) may be greater than 5 and less than 300 Wh/W, and preferably is greater than 4 and less than 300 WW, and more preferably is greater than 3 and less than 300 Wh/W, and most preferably is greater than 2 Wh/W with no particular upper limit. In addition, the peak power of the photovoltaics may be the photovoltaics' peak power rating, in watts, as measured under 1000 W/m² insolation at 25 degrees Celsius.

The electricity flowing from the photovoltaic generator 56 to the capacitor bank 66 may be further modified, controlled, converted, or regulated by an optional controller 58, which may serve many functions such as tracking the photovoltaic arrays peak-power point, charging the capacitor in an efficient means, limiting charging once the capacitor bank has reached top-of-charge or shunting power to other uses such as providing a means of heat (not shown), balancing power supplied from the PV array and the capacitor bank 66 to the load 64, and providing system feedback information to the user.

The photovoltaic energy generation system ultimately provides electricity to a load(s) 64, which may be integrated into the system or external to it. The electricity flowing to the load(s) 64 may come from the photovoltaic array 56 or the capacitor bank 66, or both depending on the availability of power or the requirements of the system. This power flowing to the load(s) 64 may be modified by an optional AC inverter or DC-DC converter 62 in order to match the needs of the load(s) 64. AC inverter 62 may also provide means of feeding electricity onto an external electric grid. Thus, each of the components described above may be individual items wired in such a way to make a single system on a per application basis, or any or all of the above components may be integrated together into a single unit or module.

One embodiment of a periodic energy generation system is shown in diagram FIG. 6, wherein the electricity is generated by a periodic energy source or multiple sources thereof 68. Examples of energy sources may include environmental sources such as photovoltaics, thermo-electric solar generators (such as solar-thermal driven sterling engines, solar-thermal steam engines, etc.), wind turbines, tidal generators, thermal gradient generators, and the like. Other examples may include heat, combustion, electrochemical, and thermo-chemical sources of energy that are operated or connected intermittently, such as combustion powered generator-sets, gas turbines, sterling engines, electric power grids, and fuel cells. The energy generated by the energy generator(s) 68 may be stored in a capacitor bank 66, such that energy is available on demand even when the energy generator(s) 68 is either not producing power or not producing sufficient power to meet the needs of the load(s) 64. The ratio of the total energy capacity of a capacitor to the energy generated by said energy generator(s) in one average day may be greater than 1 and less than 30, and preferably greater than 0.5 and less than 30, and more preferably greater than 0.25 with no particular upper limit; wherein the energy produced in an “average day” may be defined as the yearly average energy divided by 365, or the monthly average for a given month divided by the number of days in a month.

The electricity flowing from the energy generator(s) 68 to the capacitor bank 66 may be further modified, controlled, converted, or regulated by an optional controller 58, which may serve many functions such as tracking the energy generator(s) peak-power point, managing and balancing multiple energy generation sources, charging the capacitor in an efficient means, limiting charging once the capacitor bank has reached top-of-charge or shunting power to other uses such as providing a means of heat (not shown), balancing power supplied from the energy generator(s) 68 and the capacitor bank 66 to the load(s) 64, and providing system feedback information to the user.

The energy generation system ultimately provides electricity to a load(s) 64, which may be integrated into the system or external to it. The electricity flowing to the load(s) 64 may come from the energy generator(s) 68 or the capacitor bank 66, or both depending on the availability of power or the requirements of the system. This power flowing to the load(s) 64 may be modified by an AC inverter or DC-DC converter 62 in order to match the needs of the load(s) 64. The AC inverter 62 may also provide means of feeding electricity onto an external electric grid. Thus, each of the components described above may be individual items wired in such a way to make a single system on a per application basis, or any or all of the above components may be integrated together into a single unit or module.

The difference in characteristic between the high energy-density electric double layer capacitor according to an embodiment of the present invention and the conventional electric double-layer capacitor will be explained below on the basis of examples 1 to 3 and comparative examples 4 to 6.

### EXAMPLE 1

Activated carbon powder from a peat precursor is ground to an average particle size of 20 μm. The resulting powder is mixed with a powdered PTFE emulsion in a ratio of 90:10. The mixture is then kneaded, rolled, and sintered into an electrode sheet. The resulting sheets are cut into electrodes, each having the dimensions of 68.6 cm square by 0.5 cm thick and exhibit a density of 0.68 g/cc and a two-electrode capacity of 17 F/cc at 3 volts as measured via constant current charging.

A set of 10 pairs of electrodes are then formed into a single stack, thus having 10 cells in electrical series. Every two pair of electrodes, each being separated by a 0.0025 cm thick microporous polypropylene membrane, are then interposed with conductive carbon-polypropylene dividers, each 0.165 cm thick, in order to form a bipolar stack in the manner depicted in FIG. 3. The resulting stack is molded into an aluminum foil-lined polypropylene case, being 0.38 cm thick, then filled with an electrolyte containing 2.75 molar 3-ethyl-1-methylammonium tetrafluoroborate in propylene carbonate, and sealed.

The final package thus has the dimensions 69.4 cm square by 12.3 cm thick and has a capacity of 8000 farads at 30 volts, with an energy density of 16.9 Wh/liter.

### EXAMPLE 2

Activated carbon fibers from a novoloid precursor are ground into a fine powder. The resulting powder is mixed with a powdered PTFE emulsion in a ratio of 90:10. The mixture is then kneaded, rolled, and sintered into an electrode sheet. The resulting sheets are cut into electrodes have the dimensions of 57.7 cm square by 0.4 cm thick and exhibit a density of 0.85 g/cc and a two-electrode capacity of 30 F/cc at 3 volts as measured via constant current charging.

A set of 10 pairs of electrodes are then formed into a single stack, thus having 10 cells in electrical series. Every two pair of electrodes, each being separated by a microporous polypropylene membrane, are then interposed with conductive carbon-polypropylene dividers, each 0.165 cm thick, in order to form a bipolar stack in the manner illustrated in FIG. 3. The resulting stack is molded into an aluminum foil-lined polypropylene case, being 0.38 cm thick, with a 9% excess volume to accommodate the electrolyte. The case is then filled with an electrolyte containing 2.75 molar 3-ethyl-1-methylammonium tetrafluoroborate in propylene carbonate, and sealed.

The final package thus has the dimensions 61 cm square by 10.3 cm thick and has a capacity of 8000 farads at 30 volts, with an energy density of 26 Wh/liter.

### EXAMPLE 3

Highly graphitic carbon powder, having been treated in an inert atmosphere furnace at high temperature with KOH, in order to intercalate the potassium between the graphite layers, is ground into fine powder. The resulting powder is mixed with a powdered PTFE emulsion in a ratio of 90:10. The mixture is then kneaded, rolled, and sintered into an electrode sheet. The resulting sheets are cut into electrodes have the dimensions of 50 cm square by 0.3 cm thick and exhibiting a density of 0.85 g/cc and a two-electrode capacity of 40 F/cc at 4 volts as measured via constant current charging, after the fifth such charging.

A set of 10 pairs of electrodes are then formed into a single stack, thus having 10 cells in electrical series. Every two pair of electrodes, each being separated by a microporous polypropylene membrane, are then interposed with conductive carbon-polypropylene dividers, each 0.165 cm thick, in order to form a bipolar stack in the manner depicted in FIG. 3. The resulting stack is molded into an aluminum foil-lined polypropylene case, being 0.38 cm thick, then filled with an electrolyte containing 2.75 molar 3-ethyl-1-methylammonium tetrafluoroborate in propylene carbonate, and sealed.

The final package thus has the dimensions 48.3 cm square by 8.3 cm thick and has a capacity of 4500 farads and 40 volts, with an energy density of 52 Wh/liter.

### COMPARITIVE EXAMPLE 4

This comparative example is made in a similar manner as the bipolar design in example 1, only using commercial carbon electrodes having conventional carbon densities and thickness profiles. Activated carbon powder bound together with a PTFE binder was received “as is” from an electric double-layer capacitor electrode supplier. The commercial electrode sheets have a thickness of 0.0254 cm and exhibit a density of 0.37 g/cc and a two-electrode capacity of 6.5 F/cc at 3 volts as measured via constant current charging. The sheets were cut to the dimensions of 492.2 cm square to reach the capacity requirements.

A set of 10 pairs of electrodes are then formed into a single stack, thus having 10 cells in electrical series. Every two pair of electrodes, each being separated by a microporous polypropylene membrane, are then interposed with conductive carbon-polypropylene dividers, each 0.165 cm thick, in order to form a bipolar stack in the manner shown in FIG. 3. The resulting stack is molded into an aluminum foil-lined polypropylene case, being 0.38 cm thick, then filled with an electrolyte containing 2.75 molar 3-ethyl-1-methylammonium tetrafluoroborate in propylene carbonate, and sealed.

The final package thus has the dimensions 493 cm square by 2.8 cm thick and has a capacity of 8000 farads and 30 volts, with an energy density of 1.5 Wh/liter.

### COMPARITIVE EXAMPLE 5

This comparative example is made in a same manner, using the same carbon as the bipolar design in example 1, only using conventional carbon densities and thickness profiles. Activated carbon powder from a peat precursor is ground to an average particle size of 20 μm with a narrow particle size distribution as to preserve interparticle porosity and thus electrolyte conductivity to achieve high power performance, the typical goal for such a capacitor. The activated carbon powder bound together with a PTFE binder was received “as is” from an electric double-layer capacitor electrode supplier. The mixture is then kneaded, rolled, and sintered into an electrode sheet. The resulting sheets are cut into electrodes have the dimensions of 320 cm square by 0.03 cm thick and exhibit a density of 0.48 g/cc and a two-electrode capacity of 13 F/cc at 3 volts as measured via constant current charging.

A set of 10 pairs of electrodes are then formed into a single stack, thus having 10 cells in electrical series. Every two pair of electrodes, each being separated by a microporous polypropylene membrane, are then interposed with conductive carbon-polypropylene dividers, each 0.165 cm thick, in order to form a bipolar stack in the manner depicted in FIG. 3. The resulting stack is molded into an aluminum foil lined polypropylene case, being 0.38 cm thick, then filled with an electrolyte containing 1 molar tetraethylammonium tetrafluoroborate in propylene carbonate, and sealed.

The final package thus has the dimensions 321 cm square by 2.9 cm thick and has a capacity of 8000 farads and 30 volts, with an energy density of 3.4 Wh/liter.

### COMPARITIVE EXAMPLE 6

This comparative example uses the industry standard methods of packaging in a cylindrical can as illustrated in FIG. 4, and using the same activated novoloid fibers used in example 2. The activated carbon fiber fabrics were used as delivered by the manufacturer and were 0.04 cm thick and exhibit a density of 0.37 g/cc with a raw two-electrode capacity of 13 F/cc at 3 volts as measured via constant current charging. The resulting sheets are cut into electrodes having the dimensions of 38.3 cm by 2000 cm.

Each electrode is backed by an aluminum collector being 0.008 cm thick in the manner demonstrated in FIG. 4. A microporous polypropylene membrane is then interposed between the electrodes on both faces so that the electrodes are electrically isolated from one another when wound in the manner shown in FIG. 4. The wound cell is welded into an aluminum can having a wall thickness of 0.165 cm. Ten such cylindrical capacitors are placed in a single polypropylene box having a wall thickness of 0.38 cm in two rows each five cells deep, and electrically wired in series.

The final package thus has the dimensions 82.7 cm by 33.5 cm by 39.8 cm thick and has a capacity of 8000 farads and 30 volts, with an energy density of 9 Wh/liter.

Energy Generator Example Comparison

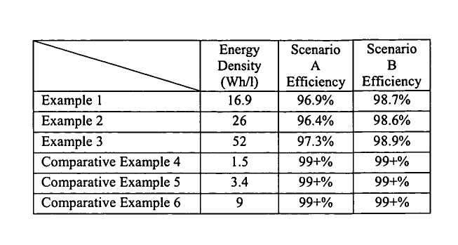

FIG. 8 illustrates the effective energy densities of the example capacitors side by side in order to show the advantage of the present invention. Alongside the energy density figures are the estimated efficiency of the said capacitors, due to any ohmic losses.

Scenario A of FIG. 8 is a periodic energy system having 2 days of capacitor energy storage, with the charge efficiency of the capacitor rated at 50% SOC. Scenario B of FIG. 8 is a periodic energy system having 5 days of capacitor energy storage, with the charge efficiency of the capacitor rated at 50% SOC. In operation, a typical periodic energy system would normally operate at a higher SOC, offering even higher efficiency than the already excellent efficiency of all the capacitors. Furthermore, the present invention will have substantially lower self-discharge due to the increased resistance of the electrolyte because of the thicker electrode conformation.

Photovoltaic and other periodic energy systems need large amounts of long-term energy storage, but have comparatively low power requirements, even at peak load. Thus, PV systems exhibit large average energy/power ratios, typically ranging from 2-200 Wh/W on the charge side to 12-300 Wh/W on the discharge side. In comparison, the prior electric double-layer capacitor art exhibit ratios in the range of 0.006 Wh/W, or less.

Previous electric double-layer capacitor efforts have produced pulsed-power designs with relatively low energy densities as illustrated in FIG. 7 and FIG. 8. The previous art proves to be poorly adaptable to bulk energy storage due to low physical capacities, low packaged active material content, high material costs per unit of energy stored, high self discharge rates, and thin, low-density, and often anisotropic electrode conformations.

The present invention is optimized for high energy densities by utilizing new cell conformations affecting electrode z-plane thickness, carbon packing densities, and ratio of active to inactive cell materials. The present invention thereby achieves substantially higher energy densities while lowering the overall cost per energy stored and significantly reduces self-discharge. While such a cell design exhibits a correspondingly higher steady-state electrical resistance, this is acceptable in periodic energy systems since the average per electrode current density may be relatively small due to the large average energy/power ratio of the application.

High energy density electric double layer capacitors have wide applicability in energy storage applications where the energy to power ratio requirements of the storage is relatively large. Such applications may include energy storage for environmental energy system sources (e.g. photovoltaics, solar, wind, etc.), gen-set and turbine load-leveling, uninterruptible power supply systems, and utility scale storage.

The present invention substantially improves the performance of storage moderated periodic energy generation systems compared to the prior art currently dominated by lead-acid batteries. Below is a point-by-point comparison of electric double layer capacitors as embodied by the present invention and lead-acid batteries as they affect periodic energy generation systems such as photovoltaic-based systems.

1. Efficiency: The periodic nature of environmental sources of energy and the quantity of storage required to ensure reliable operation typically cause photovoltaic storage systems to operate near top-of-charge. In this range, the electric double layer capacitor, as embodied by the present invention, has charge efficiencies above 90%. Under the same conditions, operating near top-of-charge, typical lead-acid batteries suffer from low charge efficiency, typically 50-70%.²
² A study of lead-acid battery efficiency near top-of-charge and the impact of PV system design. 25^{th} PVSC 1996, pp 1485-1488. J W Stevens and G P Corey.

2. Energy density and availability: The electric double layer capacitor, as embodied by the present invention, has 40-60% more available capacity given at the same nameplate capacity of lead-acids in the real world because the available energy density is nearly equal to the rated energy density. In comparison, not all lead-acid battery capacity is available in photovoltaic applications due to depth-of-discharge limits, discharge rate penalties because of blocked active material, and a linear decline in capacity over life to 50% of initial capacity at end of cycle-life.³
³ Evaluation of the batteries and charge controllers in small stand-alone photovoltaic system. First ECPEC, 1994, p 933. J Woodworth, S Harrington, J Dunlop, et al.

3. Life: The electric double layer capacitor, as embodied by the present invention, has a long cycle-life, is independent of depth-of-discharge, and may exceed well over 1,000,000 cycles at 100% depth of discharge. Lead-acid batteries achieve only 200-3,000 cycles, depending on the average depth-of-discharge. The electric double layer capacitor as embodied by the present invention has the potential to exceed the 30-year life and loan period of a photovoltaic system, whereas lead-acids typically last only 3-7 years and need many expensive replacements over the system's life.

4. Maintenance and autonomy: Photovoltaic systems utilizing the electric double layer capacitor as embodied by the present invention are virtually autonomous, requiring zero maintenance due to the sealed cell design and extremely long cycle-life of the capacitors. Battery service requirements and their associated costs are thus eliminated. The typical flooded, pasted industrial quality lead-acids, in contrast, require constant maintenance, including cell watering, electrolyte balancing, periodic overcharging, and repeated replacement.

5. Reliability: The electric double layer capacitor as embodied by the present invention has a sealed housing, long cycle-life, zero maintenance requirements, and near 100% available capacity position it as a highly reliable storage method ensuring improved system energy availability and up-time.

In contrast, batteries have a poor reliability record in PV systems and, if under-maintained, often critically fail due to water loss from a vented housing, lack of periodic overcharging, and low cycle life. In addition, their capacity decline over life, depth-of-discharge limits, and low-voltage disconnect contribute to low energy availability and increased down-time, which progressively becomes worse as the battery ages.

6. Safety: The electric double layer capacitor as embodied by the present invention may have a non-toxic carbon chemistry and sealed construction reducing battery safety risks like sulfuric acid spills, H₂ evolution, and lead contamination that must be taken into account in the construction, installation, use, and disposal of lead-acid batteries.

7. Environmental impact: The electric double layer capacitor as embodied by the present invention may be constructed from recycled organic agricultural waste, and converted to activated carbon in an energy exporting process, producing a final electrode composite which is chemically non-toxic and energy efficient.

During its potential 30-year operative life, the sealed housing prevents atmospheric outgassing and spills, while eliminating 4-9 sets of replacement batteries from entering the waste stream.

In contrast, the lead-acid battery has an energy intensive life-cycle, poor operational energy efficiency, and environmentally hazardous disposal of multiple over-capacity battery sets. Batteries also impact external governmental costs related to regulation, recycling, enforcement, health impact, and environmental remediation.

8. Embodied energy: Because converting carbonaceous feedstocks to activated carbon is an exothermic process, the manufacture of the electric double layer capacitor as embodied by the present invention produces more energy than it consumes. In comparison, lead-acid battery manufacture consumes significant amounts of energy. When combined with the effects of short life span and low energy availability, lead-acid batteries consume a large portion of the energy pay-back period (EPBP) of a photovoltaic system.

Whereas the present invention has been described with reference to multiple embodiments of the energy storage system, it will be understood that the invention is not limited to the disclosed embodiments. On the contrary, the present invention is intended to encompass all modifications, alternatives, and equivalents as may be included within the spirit and scope of the invention as defined by the appended claims.

1. A double layer capacitor, comprising:
a plurality of polarizable electrodes immersed in an organic electrolyte, each polarizable electrode having a thickness, a capacitive density, and a composition;
wherein the composition primarily comprises a carbonaceous material; and
wherein the thickness squared, as measured in centimeters across the narrowest face dimension, multiplied by the capacitive density, as measured in farads per cubic centimeter of electrode, is greater than 0.72.

2. The electrode of claim 1, wherein the thickness squared, as measured in centimeters across the narrowest face dimension, multiplied by the capacitive density, as measured in farads per cubic centimeter of electrode, is greater than 1.44.

3. The electrode of claim 1, wherein the thickness squared, as measured in centimeters across the narrowest face dimension, multiplied by the capacitive density, as measured in farads per cubic centimeter of electrode, is greater than 5.

4. The electrode of claim 1 wherein the thickness squared, as measured in centimeters across the narrowest face dimension, multiplied by the capacitive density, as measured in farads per cubic centimeter of electrode, is greater than 10 and less than 6500.

5. An energy generation system comprising:
a photovoltaic energy source; and
an energy storage subsystem comprising at least one electric double layer capacitor conforming to claim 1, the energy storage subsystem configured to provide energy when the photovoltaic energy source is insufficient to fulfill power demand.

6. The energy generation system of claim 5, wherein the ratio of the total energy storage capacity at full charge of the energy storage subsystem is greater than 2 Watt-hours per peak watt (Wh/W) of the photovoltaic energy source under conditions of 1000 watts/meter² of solar irradiation at 25 degrees Celsius.

7. The energy generation system of claim 6, wherein the ratio of the peak power rating of the energy storage subsystem to the total energy storage capacity the energy storage subsystem falls between a range of 3 to 300 Wh/W.

8. The energy generation system of claim 6, wherein the ratio of the peak power rating of the energy storage subsystem to the total energy storage capacity the energy storage subsystem falls between a range of 5 to 300 Wh/W.

9. The energy generation system of claim 6, further comprising an electric generator configured as a co-generating source of energy.

10. An energy generation system comprising:
at least one intermittent energy source; and
an energy storage subsystem comprising at least one electric double layer capacitor conforming to claim 1, the energy storage subsystem configured to provide energy when the at least one intermittent energy source is insufficient to fulfill current demand.

11. The energy generation system of claim 10, wherein the ratio of the total energy capacity of the energy storage subsystem to the daily average load is greater than 0.5

12. The energy generation system of claim 10, wherein the ratio of the total energy capacity of the energy storage subsystem to the average daily energy capacity of the at least one intermittent energy source is greater than 0.25 and less than 30.

13. The energy generation system of claim 10, wherein the at least one intermittent energy source comprises an energy source selected from the group consisting of a photovoltaic system, a thermo-electric solar generator, a wind turbine, a tidal generator, a thermal gradient generator, a combustion powered generator-set, a gas turbine, a sterling engine, an electric power grid, and fuel cells.

14. The energy generation system of claim 10, further comprising a controller configured to manage the energy storage subsystem for proposes including: charging of the capacitors by the energy generator; DC-DC conversion; constant voltage, current, or power charging of the storage sub-system, management of the capacitors' state of charge; management of the power generation sources; and prevention of capacitor overcharge.

15. The energy generation system of claim 14, wherein the controller is further configured to track energy production of the photovoltaic array.

16. The energy generation system of claim 10, further comprising an inverter or DC-DC converter configured to convert energy available from the energy storage subsystem to power required by the load.

17. The energy generation system of claim 10, wherein the energy generation system may be stand-alone, supplying electricity to a specific set of loads, where said loads may be integrated into the system or external to it, or connected to an external electric grid, whereby it provides on-demand electricity to the grid, while providing a means of backup power.
